(19) United States
(12) Patent Application Publication
(10) Pub. No.: US 2010/0007581 A1
(43) Pub. Date: Jan. 14, 2010

(54) HEAD MOUNT DISPLAY DEVICE

(75) Inventors: Shigeru Kato, Kawasaki-shi (JP); Nobuyuki Miyake, Hiratsuka-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/377,494

(22) PCT Filed: Aug. 1, 2007
(86) PCT No.: PCT/JP2007/065081

§ 371 Date: May 7, 2009

(30) Foreign Application Priority Data
Aug. 17, 2006 (JP) 2006-222333

(51) Int. Cl. G09G 5/00

(52) U.S. Cl. 345/8

(57) ABSTRACT

Provided is a technology for improving the wear comfort of a head-mounted display device. Cushions mounted on a head mounting band have surfaces that make contact with the user's head. The area of the contact surface of the cushion on the side whereupon a display unit is mounted is formed to be larger than the area of the contact surface of the other cushion.

### TECHNICAL FIELD

The present invention relates to a head-mounted display device.

### BACKGROUND ART

Head-mounted display devices have been conventionally used as devices for displaying an image in front of the user's eyes.

A conventional head-mounted display device includes an arm having a display attached to the tip thereof, wherein the arm is freely rotatable about one of a pair of speakers joined to both ends of a head mounting band that is mounted on the user's head. When viewing an image displayed on the display, the display is rotated to a position in front of the user's eye. When viewing of the image displayed on the display is temporarily paused, the display is rotated from a position in front of the user's eye to a position near the top of the user's head (see Patent Literature 1, for example).

Patent Literature 1: Japanese Unexamined Patent Application Publication No. 2004-80679

### DISCLOSURE OF THE INVENTION

### Problem to be Solved by the Invention

In conventional head-mounted display devices, the head mounting band is constructed with elastic materials, wherein the spacing between the speakers attached to both ends of the head mounting band is made to be shorter than the width of the user's head. Thus, when the head-mounted display device is mounted on the user's head, the speakers attached to both ends of the head mounting band are pressed inwardly towards the user's head, thereby allowing the head-mounted display device to be securely mounted to the user's head.

However, since the display, the arm, and a control circuit controlling an image signal or similar information displayed on the display are also built into the head-mounted display device in addition to the speakers, the weight of the head-mounted display device is increased. As a result, the applied force imparted by the speakers to the user's head must be increased, and it is hardly a comfortable device to wear it.

In addition, since the display, the arm, and the control circuit are attached on one end of the head mounting band in a conventional head-mounted display device, the weight balance is shifted to one side, and thus the weight on the user's head is also shifted to one side, which becomes another factor worsening the wear comfort of the head-mounted display device.

For this reason, it is an object of the present invention to provide technology for improving the wear comfort of a head-mounted display device.

### Means to Solve the Problem

In order to solve the above problems, it is an object of the invention according to claim 1 to provide a head-mounted display device provided with a mounting body mounted to a user's head, wherein: the mounting body includes a head mounting band, an arm unit joined rotatably to one end of the head mounting band, and a display unit attached to the tip of the arm unit; and, on the head mounting band, a cushion is formed at a position that makes contact with the user's head.

In addition, the invention according to claim 2 provides the head-mounted display device according to claim 1, wherein: the one side of the cushion out from the center of the head mounting band has a size larger than the other side of the head mounting band.

In addition, the invention according to claim 3 provides the head-mounted display device according to claim 2, wherein: the cushion has a contact surface that can be adjusted to all type of the user's head, and the contact surface of the one side of the cushion out from the center of the head mounting band is formed to have a size larger than the other side of the head mounting band.

In addition, the invention according to claim 4 provides the head-mounted display device according to claim 3, wherein: the surface area of the contact surface is formed in accordance with the proportion of the weight of the mounting body positioned on one end of the head mounting band away from the center versus the weight of the head mounting body positioned on the other end.

In addition, the invention according to claim 5 provides the head-mounted display device according to claim 4, wherein: the proportion of the surface area of the contact surface positioned on one end of the head mounting band away from the center versus the surface area of the contact surface positioned on the other end is formed to be within a range of ±10% with respect to the proportion of the weight of the mounting body positioned on one end of the head mounting band away from the center versus the weight of the head mounting body positioned on the other end.

In addition, the invention according to claim 6 provides the head-mounted display device according to claim 5, wherein: the proportion of the s of the contact surface positioned on one end of the head mounting band away from the center versus the surface area of the contact surface positioned on the other end is formed to be equal to the proportion of the weight of the mounting body positioned on one end of the head mounting band away from the center versus the weight of the head mounting body positioned on the other end.

In addition, the invention according to claim 7 provides the head-mounted display device according to any of claims 1 to 6, wherein: the cushion is formed with a first cushion attached on one end of the head mounting band away from the center and a second cushion attached on the other end, wherein the first cushion and the second cushion are attached towards the respective ends of the head mounting band away from the center and separated by 20% to 40% of the length of the head mounting band.

In addition, the invention according to claim 8 provides the head-mounted display device according to claim 7, wherein: the cushion is formed having an additional third cushion attached at a position corresponding to the center of the head mounting band.

### ADVANTAGES OF THE INVENTION

According to the present invention as described above, a cushion is provided that extends inwards from the head mounting band. As a result, the head-mounted display device is also supported by the cushion portions, thereby improving the wear comfort of the head-mounted display device.

### BRIEF DESCRIPTION OF THE DRAWINGS

FIG. 1 is a perspective diagram of a head-mounted display device 100 in accordance with a first embodiment.

FIG. 2 is a schematic diagram illustrating the circuit layout of the head-mounted display device 100.

FIG. 3 is a cross-section diagram viewed from the direction indicated by the arrows along the line X-X in the case where the display unit 170 opposes the head mounting band 120 as shown in FIG. 1.

FIG. 4 is a front view of the device body 110.

FIG. 5 is a perspective diagram of the head-mounted display device 100 in accordance with a modification of the first embodiment.

FIG. 6 is a perspective diagram of a head-mounted display device 200 in accordance with a second embodiment.

FIG. 7 is a top view of the device body 210.

FIG. 8 is a perspective diagram of a head-mounted display device 200 in accordance with a modification of the second embodiment.

FIG. 9 is a perspective diagram of a head-mounted display device 300 in accordance with a third embodiment.

FIG. 10 is a front view of the device body 310.

FIG. 11 is a perspective diagram of a modification of the head-mounted display device 100 shown in FIG. 1.

### DESCRIPTION OF THE SYMBOLS

100, 200, 300: head-mounted display device; 110, 210, 310: device body; 120, 220: head mounting band; 130, 230: speakers; 140: display circuit unit; 150: support unit; 160: arm unit; 170: display unit; 180, 280, 380: cushions; 190: controller; 199: cable

### BEST MODES FOR CARRYING OUT THE INVENTION

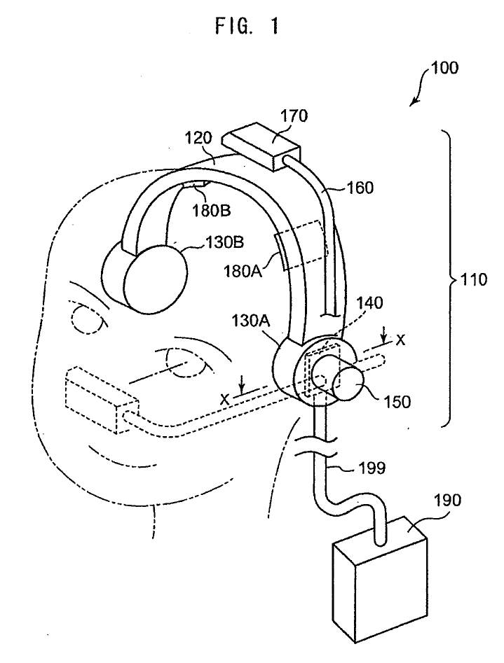

FIG. 1 is a perspective diagram of a head-mounted display device 100 in accordance with a first embodiment of the present invention.

As shown in FIG. 1, the head-mounted display device 100 is provided with a device body 110 that is mounted to the user's head, a controller 190 that acts as a transmission mechanism for transmitting signals to the device body 110, and a cable 199.

Additionally, the device body 110 is provided with a head mounting band 120, speakers 130A and 130B, a display circuit 140, a support unit 150, an arm unit 160, a display unit 170, and cushions 180A and 180B.

As shown in FIG. 1, the head mounting band 120 in the present embodiment is formed in a band shape, thus has a shape which is curved in the lengthwise direction along the shape of the user's head.

Herein, in the present embodiment, the speakers 130A and 130B are provided on either lengthwise end of the head mounting band 120.

In addition, the head mounting band 120 in the present embodiment is formed by a material having predetermined elasticity, and the spacing between the speakers 130A and 130B that are formed on either lengthwise end of the head mounting band 120 is made to be smaller than the width of the user's head. In so doing, when the head mounting band 120 is mounted on the user's head, the speakers 130A and 130B provided on either end of the head mounting band 120 are pressed inwardly towards the user's head.

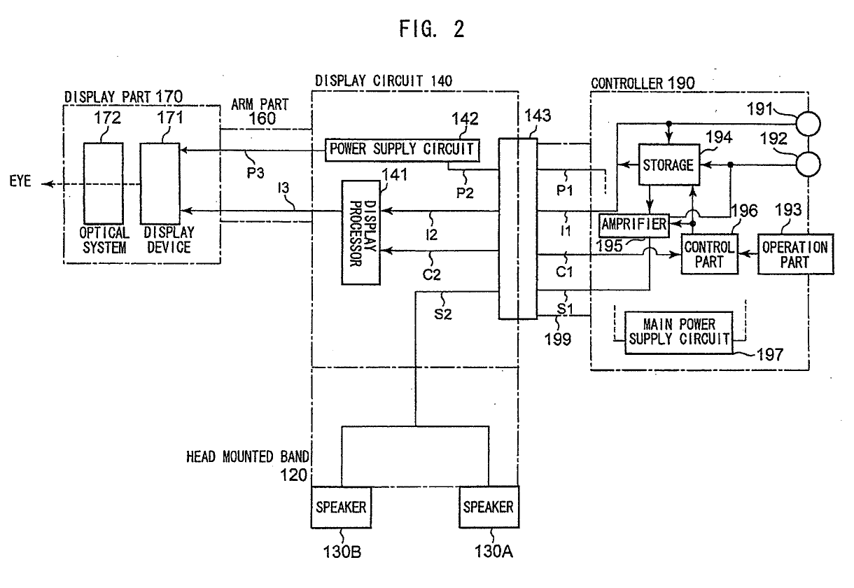

In addition, as shown in FIG. 2 (a schematic diagram illustrating the circuit layout of the head-mounted display device 100), the head mounting band 120 in the present embodiment is provided with an audio signal line S2 that supplies audio signals to the speakers 130A and 130B from the display circuit 140.

The speakers 130A and 130B are used as a conventional headphone speakers that cover both of the user's ears. Since conventional headphone speakers may be employed herein, further description thereof is omitted.

Herein, in the present embodiment, the display circuit 140 is provided in the speaker 130A on the right side as seen in FIG. 1.

As shown in FIG. 2, the display circuit 140 is provided with: a display processor 141 that sends an image signal to a display device 171 provided in the display unit 170 to be hereinafter described; a power circuit 142 that supplies power to the display processor 141 and the display device 171; and a cable connector 143 for connecting the display circuit 140 to the cable 199 to be hereinafter described.

The cable connector 143 is connected to the controller 190 to be hereinafter described by a power line P1, an image signal line I1, a control signal line C1, and an audio signal line S1. Power supplied from the power line P1 is sent to the power circuit 142, an image signal supplied from the image signal line I1 and a control signal supplied from the control signal line C1 are both sent to the display processor 141, and an audio signal supplied from the audio signal line S1 is sent to the speakers 130A and 130B.

Attached to the speaker 130A shown in the right side part of FIG. 1 is a support unit 150. Via the support unit 150, an arm unit 160 is joined to the speaker 130A rotatably.

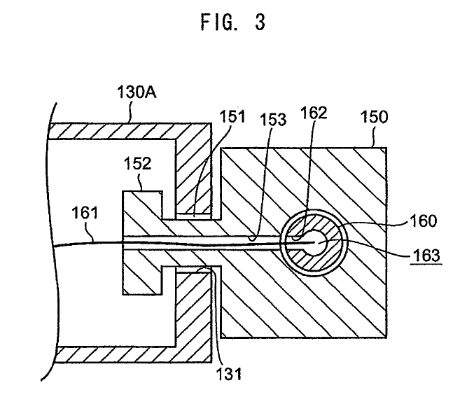

For example, as shown in FIG. 3 (a cross-section diagram viewed from the direction indicated by the arrows along the line X-X in the case where the display unit 170 opposes the head mounting band 120 as shown in FIG. 1), the support unit 150 is provided with a cylindrical axis 151 extending inwardly towards the speaker 130A. The axis 151 is inserted into a cylindrical through-hole 131 formed on the speaker 130A, and a flange 152 is also provided at the tip of the axis 151 at the inner side the speaker 130A. In so doing, the support unit 150 and the speaker 130A are joined rotatably.

Herein, it is preferable to suitably design the inner diameter of the through-hole 131 and the outer diameter of the axis 151 such that a predetermined amount of friction torque is generated between the through-hole 131 and the axis 151. It is also possible to insert a friction member between the through-hole 131 and the axis 151 such that a predetermined amount of friction torque is generated therebetween.

In addition, in the support unit 150, a through-hole 153 is formed in the same direction as the axial line of the axis 151. Via the through-hole 153, a cable 161 having a power line P3 and an image signal line 13 extends from the display circuit 140 to the arm unit 160.

Furthermore, a through-hole 162 is formed in the arm unit 160 at a position corresponding to that of the through-hole 153, with the cable 161 being pulled into an internal space 163 of the arm unit 160.

One end of the arm unit 160 is thus joined to the speaker 130A via the support unit 150 rotatably, while the tip of the other end is joined to the display unit 170.

Herein, the arm unit 160 is formed using a rod-shaped member having a predetermined length such that the display unit 170 attached to the tip of the arm unit 160 is positioned in front of the user's face when the head mounting band 120 is mounted on the user's head. In addition, the display screen of the display unit 170 is curved in the lengthwise direction so as to face in front of the user's eyes.

Furthermore, as shown in FIG. 2, the arm unit 160 is provided with a power line P3 for supplying power from the power circuit 142 to the display device 171, and an image signal line 13 for supplying an image signal from the display processor 141 to the display device 171.

The display unit 170 is joined to the tip of the arm unit 160 rotatably. As shown in FIG. 2, the display unit 170 includes a display device 171 that displays images on the basis of an image signal supplied from the display processor 141, and optical system 172 that alters the emission direction of the image displayed by the display device 171.

Attached to the head mounting band 120 in the present embodiment are cushions 180A and 180B that make contact with the user's head.

The cushions 180A and 180B are for holding the head-mounted display device 100 against the user's head, and any material may be used therefor, so long as an above object can be realized. However, since the cushions 180A and 180B are directly contacted with the user's head, it is preferable to form the cushions 180A and 180B by a soft material for at least the portions that make contact with the user's head.

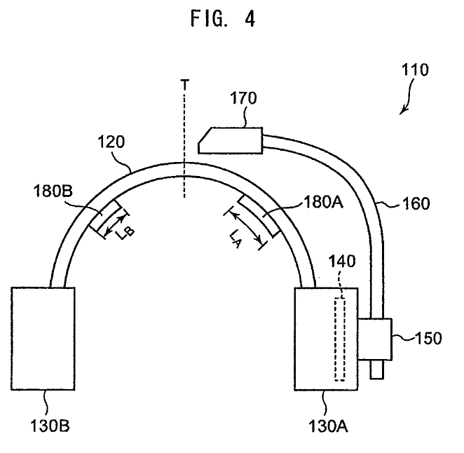

Herein, as shown in FIG. 4 (a front view of the device body 110), the two cushions 180A and 180B are provided on either side of the center T (the axis of symmetry) of the head mounting band 120, with the cushion 180A on the right and the cushion 180B on the left.

In addition, the surface size of the right-side cushion 180A (i.e., the surface area of the contact surface that makes contact with the user's head) is made to be larger than the surface size of the left-side cushion 180B (i.e., the surface area of the contact surface that makes contact with the user's head). Since the display circuit 140, the support unit 150, the arm unit 160, and the display unit 170 are attached to the right-side speaker 130A as seen in FIG. 4, the load imparted on the right side is relatively greater. The object of the increased surface area of the cushion 180A is to disperse such a load.

Herein, to what degree the size of the contact surface of the right-side cushion 180A is made larger than the contact surface of the left-side cushion 180B is a design parameter that may be suitably selected within a range whereby the larger load placed on the right side can be dispersed.

In this regard, according to the present embodiment, the proportion of the weight of the device body 110 on the right side versus the weight of the device body 110 on the left side about the center T of the head mounting band 120 is designed to be equal to the proportion of the surface area of the contact surface of the right-side cushion 180A versus the surface area of the contact surface of the left-side cushion 180B. The above proportions need not to be strictly equal, and may be sufficient to be kept within a range of approximately ±10%. For example, if the proportion of the weight W_{A} of the device body 110 on the right side versus the weight W_{B} of the device body 110 on the left-side is W_{A}:W_{B}=2:1, then the proportion of the surface area SA of the contact surface of the right-side cushion 180A versus the surface area SB of the contact surface of the left-side cushion 180B may be within the range 2:0.9 to 2:1.1.

Additionally, in the present embodiment, since the widths of the cushions 180A and 180B are similarly formed, the proportion of the lengths of the cushions (L_{A}:L_{B}) becomes equal to the proportion of the weights of the device body 110 on the respective sides thereof.

The proportion of the size of the contact surfaces of the cushions 180A and 180B attached on the right and left sides is thus equal to the proportion of the weights of the device body 110 on the respective sides thereof. As a result, the imparted weights per unit surface area for the cushions 180A and 180B become equal, and thus the weight imparted to the cushions 180A and 180B is dispersed so as to improve wear comfort.

The controller 190 is connected to the display circuit 140 provided in the speaker 130A via the cable 199, and conducts overall control of the head-mounted display device 100.

As shown in FIG. 2, the controller 190 in the present embodiment is provided with: an image signal receiving terminal 191 that receives an external image signal; an audio signal receiving terminal 192 that receives an external audio signal; an operation unit 193 whereby the user input predetermined instructions; a storage unit 194 that stores the image signal and the audio signal; an amp 195 that amplifies the audio signal; a controller 196 that generates control signals to be sent to respective components according to instructions input via the operation unit 193; and a master power circuit 197.

In the case where the display unit 170 and the speakers 130A and 130B are arranged as shown in FIG. 1, the display unit 170 is placed in front of the user's left eye, the speaker 130A covers the user's left ear, and the speaker 130B covers the user's right ear. However, by rotating the display unit 170 together with the arm unit 160 by approximately 180° around the support unit 150, for example, it is possible to arrange the display unit 170 and the speakers 130A and 130B such that the display unit 170 is placed in front of the user's right eye, the speaker 130A covers the right ear, and the speaker 130B covers the user's left ear.

In the above case, it is necessary to reverse the top/bottom sides of the image displayed by the display unit 170 as well as the left/right sides of the audio signal sent to the speakers 130A and 130B. However, in the present embodiment, the controller 196 serves to reverse the top/bottom sides of the image signal and the left/right sides of the audio signal in accordance with the user instruction for reversing inputted through the operation unit 193 of the controller 190.

In the head-mounted display device 100 of the present embodiment configured as described above, the cushions 180A and 180B are attached to the head mounting band 120, thereby dispersing and supporting the weight of the display circuit 140, the arm unit 160, and the display unit 170 on the user's head. In addition, the areas of the contact surfaces of the cushions 180A and 180B are made to be a size corresponding to the proportion of the weights of the respective sides of the device body 110 to which the cushions 180A and 180B belong. Consequently, the respective loads imparted to the cushions are dispersed equally, thereby improving the users wear comfort.

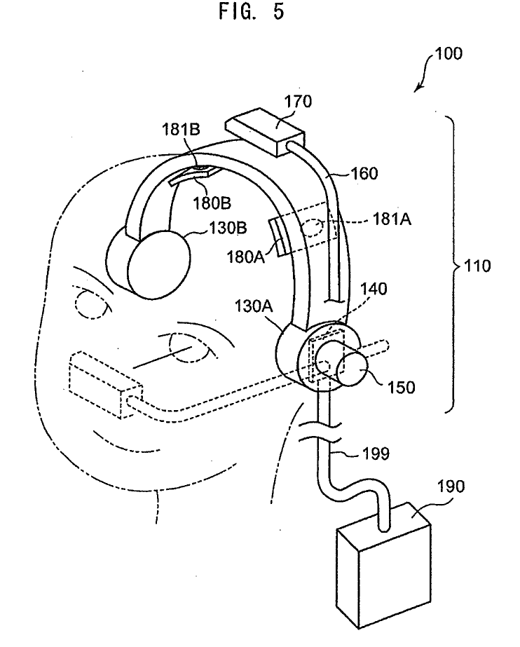

It should be appreciated that the configurations of the cushions 180A and 180B are not limited to those configurations described above. For example, as shown in FIG. 5 (a perspective diagram of the head-mounted display device 100 in accordance with a modification of the first embodiment), it is also possible to insert elastic members such as the springs 181A and 181B between the cushions 180A and 180B and the head mounting band 120.

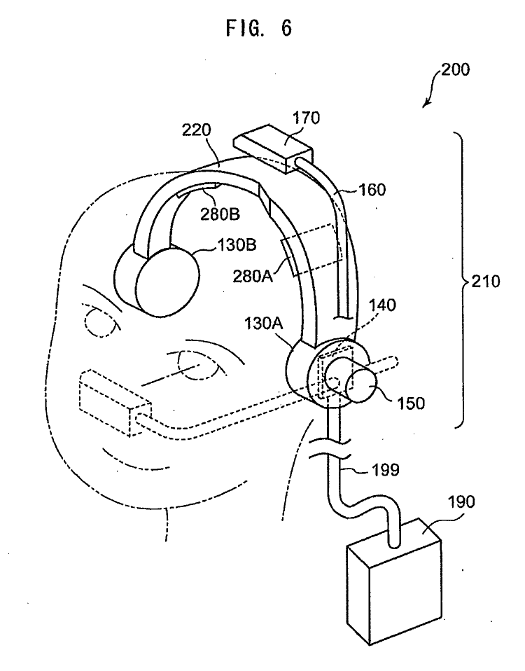

FIG. 6 is a perspective diagram of a head-mounted display device 200 in accordance with a second embodiment.

As shown in FIG. 6, the head-mounted display device 200 is provided with a device body 210, the controller 190, and the cable 199. The device body 210 is provided with a head mounting band 220, the speakers 130A and 130B, the display circuit 140, the support unit 150, the arm unit 160, the display unit 170, and cushions 280A and 280B.

Herein, the head-mounted display device 200 in the present embodiment differs from the head-mounted display device 100 of the first embodiment with respect to the head mounting band 220 and the cushions 280A and 280B, and thus items related to these points of difference will be described hereinafter.

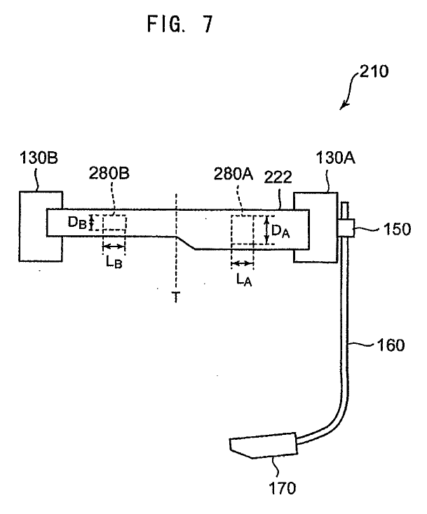

As shown in FIG. 7 (a top view of the device body 210), the head mounting band 220 in the present embodiment is such that the width on the right side when viewed from the front (i.e., the side on which the display unit 170 is attached) has been made greater than the width on the left side when viewed from the front.

In addition, the cushions 280A and 280B attached to the head mounting band 220 that has been formed in such a way that the width D_{A} of the right-side cushion 280A is greater than the width D_{B} of the left-side cushion 280B.

Unlike the first embodiment, according to the present embodiment, the length L_{A} of the right-side cushion 280A is equal to the length L_{B} of the left-side cushion 280B.

As described above, in the present embodiment, the lengths of the cushions 280A and 280B are equal, while the widths thereof are made to differ from each other. Consequently, and similarly to the first embodiment, the area of the contact surfaces of the cushions 280A and 280B are made to be a size corresponding to the proportion of the weights of the device body 210 on either side around the center T of the head mounting band 220 to which the cushions 280A and 280B belong.

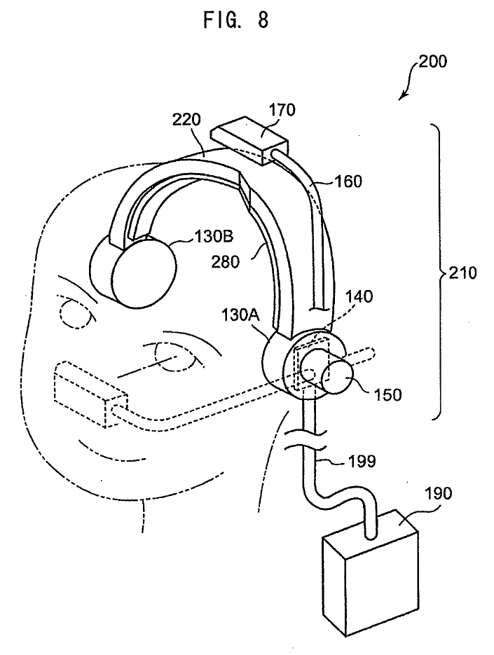

In the embodiments specified above, two cushions are provided on the head mounting band 120 and the head mounting band 220, described above as the right-side cushions 180A and 280A, and the left-side cushions 180B and 280B. However, the present invention is not limited to such a configuration, and it is also possible to provide a single cushion 280, as illustrated in FIG. 8 (a perspective diagram of a head-mounted display device 200 in accordance with a modification of the second embodiment), for example.

When a single cushion 280 is provided as described above, it is preferable to modify the width of the cushion 280 according to location, thereby making the size of the contact surface of the cushion 280 divided at the center T of the head mounting band 220 correspond to the weights of the respective sides of the device body 210.

Furthermore, although not shown in the figures, it is also possible to provide three or more cushions on either side of the center T of the head mounting band 220. In this case, the total size of areas of the contact surface of the cushions on either side of the head mounting band 220 as separated by the center T are preferably made to be corresponding to the proportion of the weights of the respective sides of the device body.

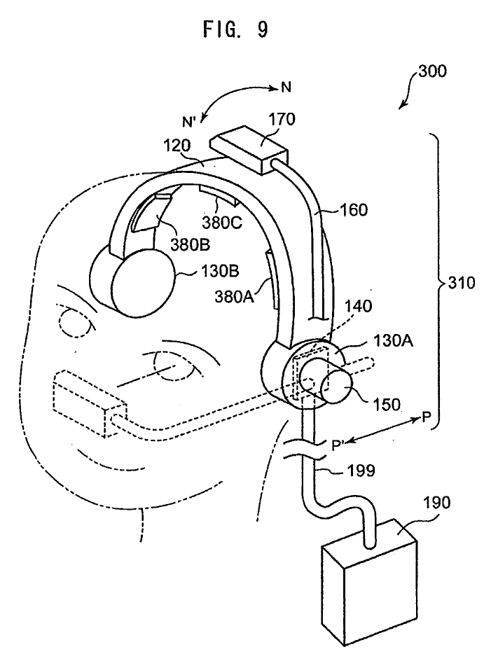

FIG. 9 is a perspective diagram of a head-mounted display device 300 in accordance with a third embodiment of the present invention.

As shown in FIG. 9, the head-mounted display device 300 is provided with a device body 310, the controller 190, and the cable 199. The device body 310 is provided with a head mounting band 320, the speakers 130A and 130B, the display circuit 140, the support unit 150, the arm unit 160, the display unit 170, and cushions 380A, 380B, and 380C.

Herein, the head-mounted display device 300 in the present embodiment differs from the head-mounted display device 100 of the first embodiment with respect to the cushions 380A, 380B, and 380C, and thus items related to these points of difference will be described hereinafter.

In the first embodiment, the two cushions 180A and 180B were provided, whereas in the present embodiment, the three cushions 380A, 380B, and 380C are provided.

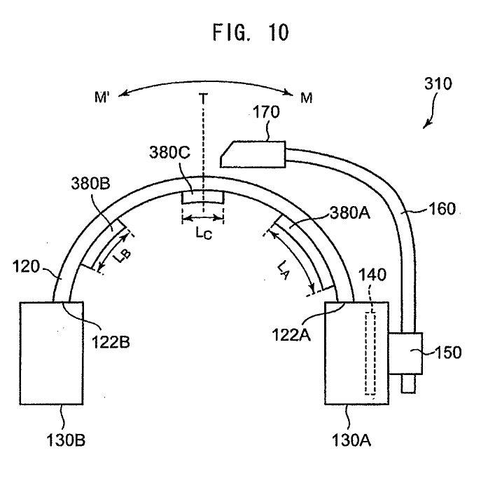

As shown in FIG. 10 (a front view of the device body 310), in the present embodiment, the cushion 380C is provided at a position overlapping the center T of the head mounting band 120. On the right side of the center T (i.e., the side to which display unit 170 is attached), the cushion 380A is provided, and on the left side of the center T, the cushion 380B is provided.

Herein, the lengths L_{A} and L_{B} of the cushions 380A and 380B are made to be longer than the widths thereof (not shown in the figure, due to being in the orthogonal direction with respect to FIG. 10). In addition, the length L_{C} of the cushion 380C is made to be shorter than the width thereof (not shown in the figure, due to being in the orthogonal direction with respect to FIG. 10).

By increasing the lengths L_{A} and L_{B} of the cushions 380A and 380B, the device body 310 is prevented from moving in the lengthwise direction of the head mounting band 120 (i.e., the M direction and the M′ direction in FIG. 10). In addition, by increasing the width of the cushion 380C, the device body 310 is prevented from moving in the rotary direction of the display unit 170 (i.e., the N direction and the N′ direction in FIG. 9).

In addition, the cushions 380A and 380B are attached within the range 20% to 40% of the length between the center T of the head mounting band 120 and the respective ends 122A and 122B.

For example, in the case where the head mounting band 120 has a length of 30 cm, the cushions 380A and 380B are attached within the range 6 cm to 12 cm from the center T of the head mounting band 120 to the respective ends 122A and 122B.

By attaching the cushions 380A and 380B within such a range, the device body 310 is prevented from moving in the lengthwise direction of the head mounting band 120 (i.e., the M direction and the M′ direction in FIG. 10).

Similarly to the first embodiment, the present embodiment is formed such that the proportion of the weight of the device body 110 on the right side versus the weight of the device body 110 on the left side around the center T of the head mounting band 120 is equal to the proportion of the size of the contact surface of the right-side cushion 380A versus the size of the contact surface of the left-side cushion 380B.

Additionally, in the present embodiment, by making the lengths L_{A} and L_{B} of the cushions 380A and 380B longer than the widths, the device body 310 is prevented from moving in the lengthwise direction of the head mounting band 120 (i.e., the M direction and the M′ direction in FIG. 10). However, by making the widths of the cushions 380A and 380B longer than the lengths L_{A} and L_{B}, it is also possible to prevent the device body 110 from moving in the horizontal direction (i.e., the P direction and the P′ direction in FIG. 9), for example.

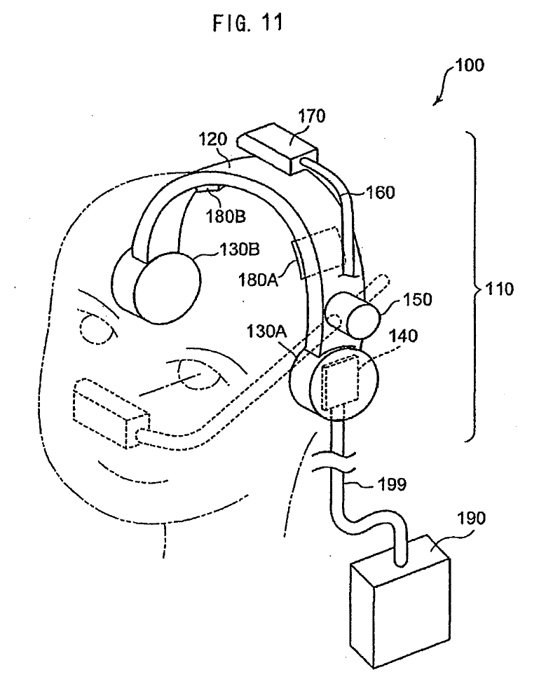

In the embodiments specified above, the display unit 170 and the arm unit 160 are joined to the speaker 130A. However, it should be appreciated that the present invention is not limited to such a configuration, and it is also possible to join the display unit 170 and the arm unit 160 to the head mounting band 120 rotatably adjacent to the speaker 130A, as shown in FIG. 11, for example. FIG. 11 is a modification of FIG. 1.

In addition, although the head mounting band 120 is formed in a band shape in the present embodiment, the present invention is not limited to such a configuration, and any configuration may be used, so long as the configuration provides a lengthwise direction on one side and the speakers 130A and 130B that can be attached to either end thereof. For example, it is possible to form a configuration by means of at least one or more rod-shaped members.

In the head-mounted display devices of the respective embodiments described above, a controller 190 is provided. However, the present invention can also be applied to a head-mounted display device configured without the controller 190, wherein a member equivalent to the controller 190 has been built into any portion of the device body 110 (such as the speakers 130A and 130B or the head mounting band 120, for example).

1. A head-mounted display device provided with a mounting body that is mounted to a user's head, wherein:
the mounting body comprises a head mounting band, an arm unit joined rotatably to one end of the head mounting band, and a display unit attached to the tip of the arm unit; and,
on the head mounting band, a cushion is formed at a position that makes contact with the user's head.

2. The head-mounted display device according to claim 1, wherein:
the one side of the cushion out from the center of the head mounting band has a size larger than the other side of the head mounting band.

3. The head-mounted display device according to claim 2, wherein:
the cushion has a contact surface that can be adjusted to all type of the user's head, and
the contact surface of the one side of the cushion out from the center of the head mounting band is formed to have a size larger than the other side of the head mounting band.

4. The head-mounted display device according to claim 3, wherein: the surface area of the contact surface is formed in accordance with the proportion of the weight of the mounting body positioned on one end of the head mounting band away from the center versus the weight of the head mounting body positioned on the other end.

5. The head-mounted display device according to claim 4, wherein: the proportion of the surface size of the contact surface positioned on one end of the head mounting band away from the center versus the surface size of the contact surface positioned on the other end is formed to be within a range of ±10% with respect to the proportion of the weight of the mounting body positioned on one end of the head mounting band away from the center versus the weight of the head mounting body positioned on the other end.

6. The head-mounted display device according to claim 5, wherein: the proportion of the surface size of the contact surface positioned on one end of the head mounting band away from the center versus the surface size of the contact surface positioned on the other end is formed to be equal to the proportion of the weight of the mounting body positioned on one end of the head mounting band away from the center versus the weight of the head mounting body positioned on the other end.

7. The head-mounted display device according to claim 1, wherein:
the cushion is formed with a first cushion attached on one end of the head mounting band away from the center and a second cushion attached on the other end; and
the first cushion and the second cushion are attached towards the respective ends of the head mounting band away from the center and separated by 20% to 40% of the length of the head mounting band.

8. The head-mounted display device according to claim 7, wherein: the cushion is formed having an additional third cushion attached at a position corresponding to the center of the head mounting band.

9. The head-mounted display device according to claim 2, wherein:
the cushion is formed with a first cushion attached on one end of the head mounting band away from the center and a second cushion attached on the other end; and
the first cushion and the second cushion are attached towards the respective ends of the head mounting band away from the center and separated by 20% to 40% of the length of the head mounting band.

10. The head-mounted display device according to claim 3, wherein:
the cushion is formed with a first cushion attached on one end of the head mounting band away from the center and a second cushion attached on the other end; and
the first cushion and the second cushion are attached towards the respective ends of the head mounting band away from the center and separated by 20% to 40% of the length of the head mounting band.

11. The head-mounted display device according to claim 4, wherein:
the cushion is formed with a first cushion attached on one end of the head mounting band away from the center and a second cushion attached on the other end; and
the first cushion and the second cushion are attached towards the respective ends of the head mounting band away from the center and separated by 20% to 40% of the length of the head mounting band.

12. The head-mounted display device according to claim 5, wherein:
the cushion is formed with a first cushion attached on one end of the head mounting band away from the center and a second cushion attached on the other end; and
the first cushion and the second cushion are attached towards the respective ends of the head mounting band away from the center and separated by 20% to 40% of the length of the head mounting band.

13. The head-mounted display device according to claim 6, wherein:
the cushion is formed with a first cushion attached on one end of the head mounting band away from the center and a second cushion attached on the other end; and
the first cushion and the second cushion are attached towards the respective ends of the head mounting band away from the center and separated by 20% to 40% of the length of the head mounting band.
